(19) United States
(12) Patent Application Publication
(10) Pub. No.: US 2018/0292788 A1
(43) Pub. Date: Oct. 11, 2018

(54) MOBILE VIBRATING ALARM SYSTEM

(71) Applicant: Salman F.F.M.S. Alotaibi, Safat (KW)

(72) Inventor: Salman F.F.M.S. Alotaibi, Safat (KW)

(21) Appl. No.: 15/909,937

(22) Filed: Mar. 1, 2018

Related U.S. Application Data
(60) Provisional application No. 62/482,161, filed on Apr. 5, 2017.

(51) Int. Cl. G04B 25/04; A47G 9/10; G08B 25/10; G08B 6/00

(52) U.S. Cl. CPC G04B 25/04; A47G 9/1045; H04W 4/80; G08B 6/00; G08B 25/10

(57) ABSTRACT

The mobile vibrating alarm system may be used to wake a person by producing vibrations for a selected period of time. The mobile vibrating alarm system includes a vibration unit having a vibration motor, a wireless receiver, and a controller. The controller transmits actuation signals to the vibration motor such that the vibration motor is driven to activate for a selected period of time. At least one parameter of the vibration motor may be varied at regular intervals, such as the frequency of vibration, the intensity of vibration, or a combination thereof. The mobile vibrating alarm system further includes a mobile communication device, which includes a wireless transmitter for transmitting wireless signals to the wireless receiver of the vibration unit.

### CROSS-REFERENCE TO RELATED APPLICATION

This application claims the benefit of U.S. Provisional Patent Application Ser. No. 62/482,161, filed on Apr. 5, 2017.

### BACKGROUND

### 1. Field

The disclosure of the present patent application relates to alarm systems, and particularly to a mobile vibrating alarm system that includes a vibrating motor that can be placed under a pillow to wake a person using a vibration pattern programmed to change at a regular interval.

### 2. Description of the Related Art

People normally keep their smart phones on their nightstands, not only to check their e-mail and make phone calls at night, but also to conveniently charge their smart phone. There are some software applications that allow the smart phone to be used as an alarm clock. However, even with a conventional alarm, waking up at a predetermined time is often a difficult task for some people. Typically, using a conventional smart phone alarm, the smart phone will emit a sound, such as a beeping sound or music, at a predetermined time to alert the person that it is time to awake. However, there are drawbacks to using a smart phone as an alarm clock. For example, noise from smart phones, such as the music and/or a beeping sound, may awaken others in the room, such as a spouse or a roommate. Another drawback is that a person relying on his or her alarm may not only become accustomed to sleeping during the music or the beeping sound, but also may not even hear the music or beeping sound, and thus sleep through the alarm. Thus, a mobile vibrating alarm system solving the aforementioned problems is desired.

### SUMMARY

The mobile vibrating alarm system may be used to wake a person by producing vibrations for a selected period of time. The mobile vibrating alarm system includes a vibration unit having a vibration motor, a wireless receiver, and a controller. The controller transmits actuation signals to the vibration motor such that the vibration motor is driven to activate for a selected period of time. At least one parameter of the vibration motor may be varied at regular intervals, such as the frequency of vibration, the intensity of vibration, or a combination thereof. The vibration unit may also include at least one user interface, such as an on/off switch, a snooze button or the like.

The mobile vibrating alarm system further includes a mobile communication device, such as a smart phone, a computer tablet, a laptop computer, a personal digital assistant or the like. The mobile communication device has a wireless transmitter for transmitting wireless signals to the wireless receiver of the vibration unit. The wireless signals are representative of a programmable actuation time for the controller of the vibration unit to transmit the actuation signals to the vibration motor.

These and other features of the present disclosure will become readily apparent upon further review of the following specification and drawings.

### BRIEF DESCRIPTION OF THE DRAWINGS

FIG. 1A is an environmental perspective view of a mobile vibrating alarm system.

FIG. 1B is a detailed perspective view showing area 1B of FIG. 1A.

FIG. 2 is a block diagram illustrating the electronic components of a vibrating unit of the mobile vibrating alarm system.

Similar reference characters denote corresponding features consistently throughout the attached drawings.

### DETAILED DESCRIPTION OF THE PREFERRED EMBODIMENTS

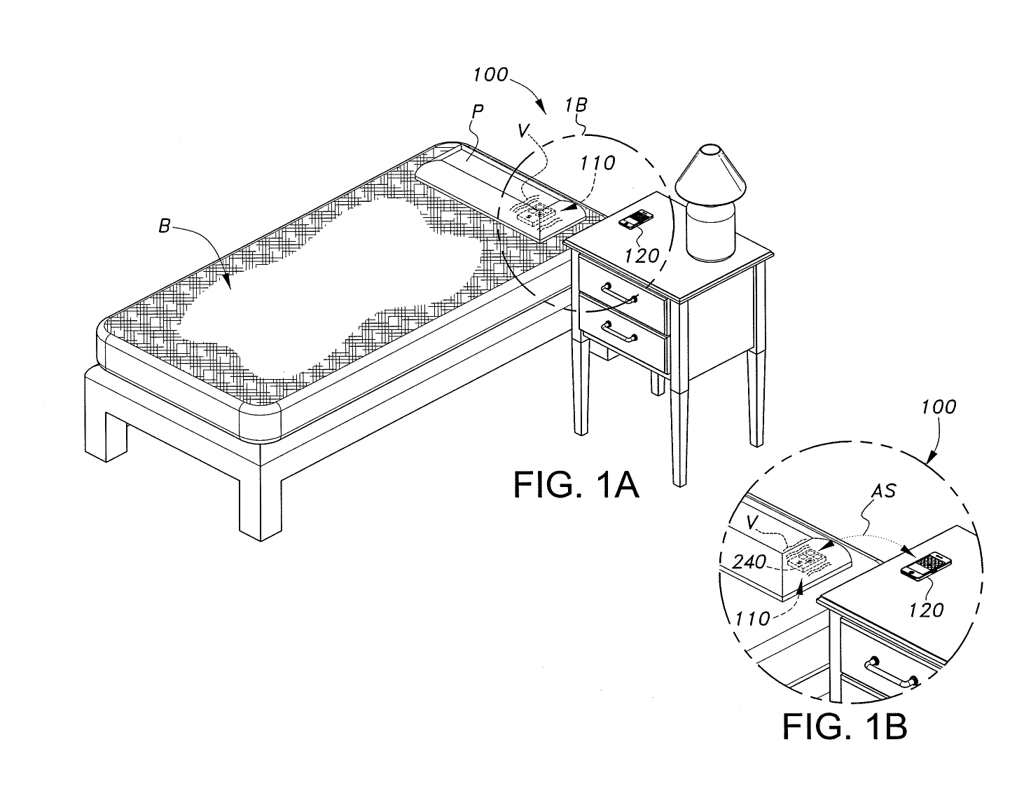

As shown in FIGS. 1A and 1B, the mobile vibrating alarm system 100 may be used to wake a person by producing vibrations V of varying frequencies for a selected amount of time. As discussed in greater detail below, the frequency of the vibrations V may be programmed to vary at regular intervals (every 24 hours, for example) such that the user will not become unresponsive due to his or her familiarity with the frequency of the vibrations V. Such varying frequency will wake the user by stimulating the reticular activating system, which is responsible for regulating wakefulness and sleep-wake transitions.

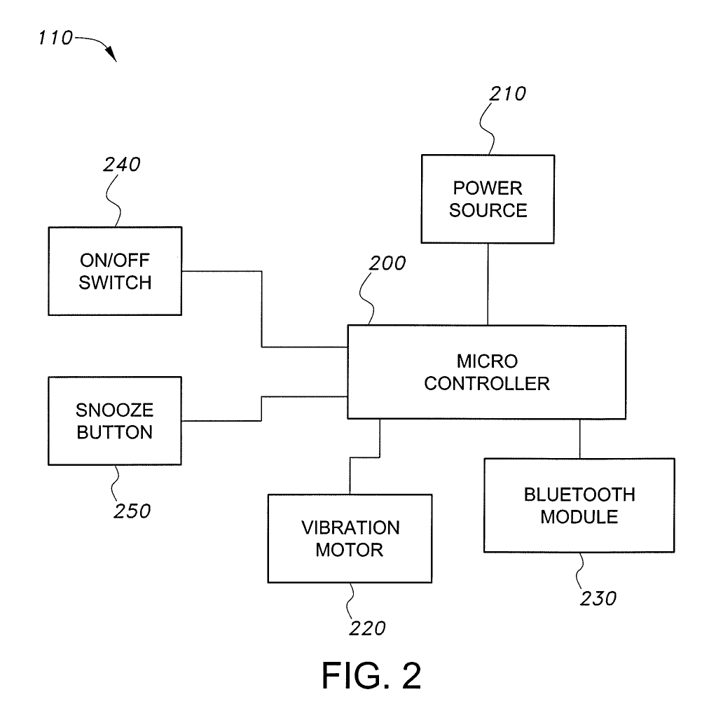

As best shown in FIGS. 1B and 2, the mobile vibrating alarm system 100 includes a vibrating unit 110 and a mobile communication device 120. It should be understood that vibrating unit 110 may use any suitable type of vibration motor 220 for generating controllable vibrations, as is well known in the art. As a non-limiting example, vibration motor 220 may be a vibration motor with an I²C Bus® interface, manufactured by Philips Electronics N.V. Corp. of the Netherlands. The mobile communication device 120 has stored thereon a mobile software application (e.g., a mobile “app”) configured for setting the vibrating unit 110 to actuate at a predetermined time. As an example, the user may program mobile communication device 120 to actuate mobile vibrating alarm system 100 at 6:00 AM.

The vibration unit 110 includes a microcontroller 200 in communication with a power source 210. It should be understood that microcontroller 200 may be any suitable type of controller, processor, programmable logic controller or the like. As a non-limiting example, microcontroller 200 may be an Arduino® Uno microcontroller, manufactured by the Arduino® AG Corporation of Switzerland. Microcontroller 200 is in communication with a wireless receiver 230, which may be any suitable type of wireless receiver allowing microcontroller 200 to communicate with mobile communication device 120 through a wireless actuation signal AS. Wireless receiver 230 may be, as a non-limiting example, a Bluetooth® module, allowing for wireless communication using the Bluetooth® wireless protocol. It should be understood that power source 210 may be any suitable type of power source. As a non-limiting example, power source 210 may be a conventional 6 V battery.

The vibration unit 110 also includes vibration motor 220, an on/off switch 240 and a snooze button 250, each in communication with the microcontroller 200. It should be understood that the on-off switch 240 and snooze button 250 may be provided in the form of any suitable type of switch, button or other conventional user interface, as is well known in the art. In use, the user programs mobile communication device 120 to transmit activation signal AS at the selected wakeup time. Although the Bluetooth® wireless protocol was given above as a non-limiting example of wireless communication between mobile communication device 120 and wireless receiver/module 230, it should be understood that any suitable type of wireless signal may be used. As further non-limiting examples, activation signal AS may be delivered via the Wi-Fi® wireless protocol, through a wireless local area network (WLAN), or through near field communication (NFC).

It should be understood that microcontroller 200, power source 210, vibration motor 220, wireless receiver/module 230, on/off switch 240 and snooze button 250 may be integrated into any suitable type of housing. For example, the housing of vibration unit 110 may be formed from a suitable material so as to not disturb a sleeping user, such as rubber or plastic. Similarly, it should be understood that the housing of vibration unit 110 may have any desired overall contouring and relative dimensions. In the example shown in FIGS. 1A and 1B, the vibration unit 110 is ergonomically shaped and sized to comfortably fit under exemplary pillow P, but is also of a convenient size and shape to be portably moved to a wearable arm band, to fit beneath a bed liner, etc. Further, it should be understood that vibration unit 110 may be releasably held in place. For example, vibration unit 110 may be releasably secured to bed B beneath pillow P (in the particular example of FIG. 1A) by attachment therebetween with a hook-and-loop fastener, double sided tape or the like. Such attachment would prevent the vibration unit 110 from becoming dislodged while the user is asleep.

As noted above, in use, the software (or “app”) stored on mobile communication device 120 is programmed by the user to wirelessly transmit activation signal AS, representative of the desired wakeup time. Upon receiving the wakeup time, the microcontroller 200 starts an internal countdown timer. At the programmed wakeup time, the microcontroller 200 provides an actuating signal to vibration motor 220, with the signal being delivered to vibration motor 220 for a pre-programmed period of time. It should be understood that mobile communication device 120 may be any suitable type of mobile communication device, such as a smart phone, a computer tablet, a laptop computer, a personal digital assistant or the like.

The processor-executable instructions from the mobile app of the mobile communication device 120 are executable by the microcontroller 210 of the vibration unit 110. The microcontroller 210 contains any suitable type of computer readable memory, such as read-only memory, field alterable flash memory, or erasable read-only memory. The microcontroller 210 may be further programed by software to vary the frequency of the vibration V on successive days. Additionally, the microcontroller 200 may also be programed to vary the intensity of the vibrations V. The memory of the microcontroller 210 can store the processor-executable instructions to enable and to facilitate the calculations, determinations, data transmission or data reception, and the sending, receiving or generating of activation signals in relation to activating the vibration motor 220, such as the processor-executable instructions configured for producing vibrations V of varying frequencies. For example, the frequency of the vibrations V can be programed to vary every 24 hours. By programing the microcontroller 200 of the vibration unit 110, the vibration motor 220 may vibrate at different frequencies (and/or intensities) each time, such that the user will not become familiar with, and/or tolerant of, the stimulus and remain asleep. It should be understood that the microcontroller 200, the power source 210, the vibration motor 220, the wireless module 230, the on/off switch 240 and the snooze button 250 are in communication with one another by any suitable type of data bus, as is well known in the art.

In use, the user first activates the vibration unit 110 by switching the on/off switch 240 on the vibration unit 110 to the “on” position. The user then programs the mobile app on the mobile communication device 120 to send the activation signal AS, representative of the wakeup time, from the mobile communication device 120 to the vibration unit 110. When the countdown timer of microcontroller 200 reaches the predetermined time, the microcontroller 200 actuates the vibration motor 220.

Once the user is awake, he or she can deactivate the vibration unit 110 by switching the on/off switch 240 on the vibration unit 110 to the “off” position. Alternatively, the user can depress the snooze button 250, temporarily deactivating vibration motor 220 for a predetermined amount of time, such as 90 seconds, for example. Once the user is awake, following the snooze period, he or she can deactivate the vibration unit 110 by switching the on/off switch 240 on the vibration unit 110 to the “off” position.

It is to be understood that the mobile vibrating alarm system is not limited to the specific embodiments described above, but encompass any and all embodiments within the scope of the generic language of the following claims enabled by the embodiments described herein, or otherwise shown in the drawings or described above in terms sufficient to enable one of ordinary skill in the art to make and use the claimed subject matter.

1. A mobile vibrating alarm system, comprising:
a vibration unit including:
a vibration motor;
a controller in communication with the vibration motor, the controller transmits actuation signals to the vibration motor such that the vibration motor is driven to activate for a selected period of time, two parameters of the vibration motor being varied automatically on successive days, wherein the two parameters are frequency and intensity, thereby preventing the user from becoming familiar with the stimulus and remain asleep; and
a wireless receiver in communication with the controller; and
a mobile communication device having a wireless transmitter for transmitting wireless signals to the wireless receiver of the vibration unit, the wireless signals being representative of a programmable actuation time for the controller of the vibration unit to transmit the actuation signals to the vibration motor.

2. (canceled)

3. The mobile vibrating alarm system as recited in claim 1, wherein the vibration unit further comprises at least one user interface.

4. The mobile vibrating alarm system as recited in claim 1, wherein the mobile communication device is selected from the group consisting of a smart phone, a computer tablet, a laptop computer, and a personal digital assistant.

5-9. (canceled)
